(19) United States
(12) Patent Application Publication
(10) Pub. No.: US 2001/0020994 A1
(43) Pub. Date: Sep. 13, 2001

(54) Liquid crystal display device

(76) Inventors: Toshiki Kaneko, Chiba (JP); Kazumi Fujii, Hitachi (JP); Masatomo Terakado, Chiba (JP)

Correspondence Address: Robert C. Colwell, TOWNSEND and TOWNSEND and CREW LLP, 8th Floor, Two Embarcadero Center, San Francisco, CA, 94111-3834, US

(21) Appl. No.: 09/782,928

(22) Filed: Feb. 13, 2001

(30) Foreign Application Priority Data
Mar. 10, 2000 (JP) JP2000-066610

(51) Int. Cl. G02F 1/1343

(52) U.S. Cl. 349/147

(57) ABSTRACT

The present invention realizes a satisfactory step coverage of a thin film to be formed over a stacked line or electrode and satisfies the adhesion of the stacked line or electrode to a substrate, and also prevents the disconnection of the overlying line of the stacked line or electrode as well as the occurrence of a short-circuit between the overlying line and the underlying line, thereby improving reliability. A line having a stacked structure is provided on an insulative substrate. The stacked structure includes a first layer made of a first metal layer and a second layer made of a second metal different from the first metal layer. Each end surface of the first layer has a forward-tapered shape, while each end surface of the second layer is formed into a shape perpendicular to a surface of the substrate or an inversely-tapered shape.

### CROSS-REFERENCES TO RELATED APPLICATIONS

The present application is related to and claims priority from Japanese Patent Application No. JP2000-066610, filed on Mar. 10, 2000.

### BACKGROUND OF THE INVENTION

The present invention relates to a liquid crystal display device and, more particularly, to a liquid crystal display device, such as a thin film transistor (TFT) type of active matrix type liquid crystal display device, which has a yield factor improved by preventing disconnection in a stacked line portion or the like.

Liquid crystal display devices are widely used as devices for displaying various kinds of pictures such as still pictures and kinematic pictures. Such liquid crystal display devices are basically classified into two types: the type (a so-called simple matrix type) in which a liquid crystal layer is interposed between two insulative substrates at least one of which is made of transparent glass or the like, and predetermined pixels are turned on or off by selectively applying voltages to pixel-forming electrodes which are formed over each of the substrates; and the type (a so-called active matrix type which uses thin film transistors (TFTs) as active elements) in which such various electrodes formed over each of the substrates as well as pixel-selecting active elements (switching elements) are formed, and predetermined pixels are turned on or off by selecting the corresponding active elements from these active elements.

In particular, the latter active matrix type of liquid crystal display device has become a leading liquid crystal display device because of its contrast performance and its high-speed display performance. The liquid crystal display device integrally includes a liquid crystal panel and various driver circuits therefore as well as a backlight and others, but, in the following description, reference will be made to the construction of a liquid crystal panel as the construction of a liquid crystal display device.

FIG. 13 is a diagrammatic cross-sectional view illustrating one example of the essential construction of an active matrix type of liquid crystal display device. In FIG. 13, reference numeral 1 denotes an active matrix substrate (an active substrate; also called a TFT substrate) which has thin film transistors. Formed over the TFT substrate 1 are a scanning signal line (a gate signal line; in FIG. 13, the scanning signal line is shown as a gate line or electrode; also hereinafter referred to simply as a gate line) 2, a video signal line (a drain signal line; in FIG. 13, the video signal line is shown as a drain electrode connected to a drain signal line; also hereinafter referred to simply as a drain line) 7, a source electrode 8, a pixel electrode 11, an insulating film 4, a semiconductor layer 5, a contact layer 6 and a protective film (a passivation film or a passivation layer) 9. Incidentally, although an alignment film is applied to the uppermost layer that is in contact with a liquid crystal LC, the illustration of the alignment film is omitted in FIG. 13.

A contact hole 10 is formed in the protective film 9, and connects the pixel electrode 11 to the source electrode 8. An added capacitance Cadd is formed of an adjacent gate line 2′ and the pixel electrode 11 to both of which one pixel is adjacent, as well as the insulating film 4 and the protective film 9.

Reference numeral 12 denotes a filter substrate. Color filters 13 which are separated by a black matrix (BM) 14 and generally correspond to three colors, a smoothing layer 15 and a counter electrode 16 are formed over the internal surface of the filter substrate 12. Although an alignment film is applied to the uppermost layer of the filter substrate 12 that is in contact with the liquid crystal layer LC, the illustration of the alignment film is omitted in FIG. 13.

In the portion of a thin film transistor TFT, the gate line (in FIG. 13, the gate electrode) 2, the insulating film 4 which is suitably made of silicon nitride SiN, the semiconductor layer 5, the contact layer 6, the drain line (in FIG. 13, the drain electrode) 7, the source electrode 8, the protective film 9, the pixel electrode 11 and the like are stacked in the form of a multilayered structure by patterning using deposition and etching treatment. In the portion of the added capacitance Cadd, the adjacent gate line 2′, the source electrode 8, the protective film 9 and the pixel electrode 11 are similarly stacked. Molybdenum (Mo) is used as the material of each of the lines or electrodes. Incidentally, the drain and source electrodes are switched therebetween during operation, but in the following description, for the sake of convenience, one of the electrodes is fixed as a drain electrode and the other is fixed as a source electrode.

As shown in FIG. 13, the gate line 2 or 2′ which is formed in the lowermost layer of the active matrix substrate 1 is worked by etching treatment so that each of its etched end portions (its etched-side end surfaces) is perpendicular to a surface of the substrate 1. For this reason, at the edge portions of the insulating film (gate insulating layer) 4 which is deposited on the gate line 2 or 2′, there occur portions which produce unsatisfactory coverages (step coverages) such as those shown by arrows C in FIG. 13 owing to those perpendicular wall surfaces, resulting in problems such as defective insulation and short-circuiting occur. This fact similarly occurs in the case of the drain line.

Lines (electrodes) using molybdenum (Mo) are suited to a large-area liquid crystal panel having a large signal line length because their resistivities are low. However, the lines (electrodes) using molybdenum (Mo) has the problem that the base adhesion of a film which constitutes the lines (electrodes) is low and they easily peel off the glass substrate 1 which is an insulative substrate, or source lines (electrodes) or drain lines (electrodes) easily peel off from the insulating film 4 which is the gate insulating layer.

In addition, the lines (electrodes) using molybdenum (Mo) have the problem that, because their resist adhesion is inferior, it is difficult to taper the side ends of the lines. As a result, the step coverage of a vacuum-evaporated film (typically, a CVD film) deposited on the lines is inferior and there is a risk that the breakdown voltage of the device degrades. This becomes one of the problems to be solved.

After such a molybdenum line (electrode) has been formed, the step of effecting patterning using dry etching is normally carried out. However, the molybdenum line (electrode) does not have resistance to drying etching. Accordingly, when the connecting through-hole 10 (in this case, the through-hole 10 for connecting the source electrode 8 and the pixel electrode 11) is formed in the insulation layer 9 formed over the molybdenum (Mo) line (electrode), the underlying molybdenum line which constitutes the source electrode 8 is also etched. This leads to the problem that through-holes are difficult to work. For this reason, it has been desired to develop molybdenum lines (electrodes) having resistance to dry etching.

Although the liquid crystal display device described above with reference to FIG. 13 is a so-called TN type (vertical electric field type) of liquid crystal display device which has the counter electrode 16 over a color filter substrate 1′, the above description similarly applies to each line or electrode in a so-called IPS mode (In-Plane Switching Mode) of liquid crystal display device in which a counter electrode having a function similar to the counter electrode 16 is formed over the active matrix substrate 1.

### SUMMARY OF THE INVENTION

The present invention solves the problems of the related art, and improves the base adhesion of molybdenum lines (electrodes), and also applies forward tapering to the etched-side end surfaces of each of the molybdenum lines (electrodes) (the side surfaces of each line or electrode formed by etching) to improve the step coverage of an insulating film or protective film deposited over the molybdenum lines (electrodes), thereby providing a highly reliable liquid crystal display device.

The present invention also provides a liquid crystal display device in which since molybdenum lines (electrodes) are imported resistance to dry etching, through-holes can be formed by the drying etching of the molybdenum lines (electrodes).

Therefore, the present invention realizes forward-tapering etching by utilizing a cell reaction caused by a difference in corrosion speed due to the corrosion potential difference between different kinds of metals in each of which an appropriate alloy element is added to molybdenum which is a basic material, and also improves the base adhesion of lines (electrodes) and the dry-etching resistance of the upper surfaces of the lines (electrodes).

The cell reaction will be described below. When a material is immersed in a solution, the oxidation-reduction potential of the material in the solution is produced. In a corrosion environmental solution, the oxidation-reduction potential of the material during melting, i.e., corrosion potential, is produced. When two different kinds of electrodes are immersed in one solution, they exhibit different corrosion potentials. If these electrodes are interconnected, a potential difference occurs and a current flows between the two kinds of electrodes. This construction is called galvanic cell, and the current is called galvanic current.

In this galvanic cell, an electrode which is lower in oxidation-reduction potential works as an anode electrode, and an oxidation reaction occurs on the surface of the anode electrode and the electrode starts to ionize and melt. On the other hand, an electrode which is lower in oxidation-reduction potential works as a cathode electrode, and at the cathode electrode, a reduction reaction of water occurs and hydrogen is produced.

An etching process utilizing a cell reaction is to promote etching at the interface between the above-described laminated films by utilizing such a cell reaction.

Incidentally, the term “forward taper” signifies an inclined surface which is formed so that a straight line which crosses at right angles an etched-side inclined end surface in a plane parallel to a substrate surface becomes shorter with an increase in the distance from the substrate surface. In addition, a shape which is formed so that an inclined surface which crosses at right angles an etched-side inclined end surface in a plane parallel to a substrate surface and becomes longer with an increase in the distance from the substrate surface is called “inverse taper”.

Following are representative aspects of the present invention:

A liquid crystal display device comprising a line or an electrode having a stacked structure made of a first metal layer is formed over an insulative substrate and a second metal layer which is different in corrosion potential from the first metal layer and is formed over the first metal layer, and wherein the first metal layer and the second metal layer being respectively made of Mo alloys which differ from each other in the kind of additive element. The effects and advantages of each of the above-described aspects will be described below.

To improve the base adhesion of molybdenum lines (electrodes), tungsten (W), tantalum (Ta) or the like is added to molybdenum as an additive element (alloy element) which improves such adhesion. Each of the lines (electrodes) is more improved in its base adhesion to a substrate such as glass with an increase in the amount by which an element is added to molybdenum (the additive element and molybdenum are line (electrode) materials).

In this case, it is desirable to lower the resistivity of such a line (electrode) material. If the resistance of the lines (electrodes) is lowered, in a thin film transistor type liquid crystal display device of the type which uses such low-resistance lines (electrodes), its signal delay can be decreased and even an increase in the screen area of the liquid crystal display device can easily be coped with.

FIG. 1 is a graph illustrating variations in resistivity which respectively correspond to the amounts by which different kinds of elements are added to molybdenum (Mo), and the horizontal axis represents the amount by which each element is added to molybdenum (Mo), while the vertical axis represents resistivity (μΩcm). If only an improvement in base adhesion is noticed, it is more preferable to add an element to molybdenum (Mo) in a greater amount. However, there are some kinds of elements whose resistivities become unacceptably large with increases in their added amounts.

In FIG. 1, additional elements such as chromium (Cr), vanadium (V) and niobium (Nb) increase in resistivity to an extreme extent as their added amounts are increased. In contrast, the proportions of increases in the resistivities of tungsten (W), tantalum (Ta) and titanium (Ti) to increases in their respective added amounts are small. In particular, since the resistivities of tungsten (W) and tantalum (Ta) increase comparatively moderately, it is apparent that tungsten (W) and tantalum (Ta) are suited to elements to be added to molybdenum.

However, line layers each of which is made of either of molybdenum alloys to which tungsten (W) and tantalum (Ta) are respectively added are small in resistance to dry etching. The resistance to drying etching is explained as the dry-etching rate per unit time.

FIG. 2 is a graph illustrating dry-etching rates based on the respective elements added to molybdenum, and the horizontal axis represents the amount of each of the added elements (at %), while the vertical axis represents drying-etching rate (nm/s). Incidentally, FIG. 2 shows the results obtained by measuring the dry-etching resistances of the lines of different line layers when CVD films of silicon nitride (SiN) are deposited on the respective line layers as insulating films and these insulating films are worked at a dry-etching rate of 7.3 nm by using a gas which essentially contains fluorine.

As shown in FIG. 2, in the case of the lines each made of either of the alloys which respectively use tungsten (W) and tantalum (Ta) as elements added to molybdenum (Mo), their dry-etching rates do not slow down to a great extent. That is to say, as elements to be added to molybdenum, tungsten (W) and tantalum (Ta) are not effective in improving the dry-etching resistance of the upper surface of the line (electrode) layer. This fact means that tungsten (W) and tantalum (Ta) themselves are easily etched by a gas which essentially contains fluorine and even if tungsten (W) and tantalum (Ta) are alloyed with molybdenum (Mo), the resultant dry-etching rates slightly slow down but the resistance to dry etching cannot be improved to a great extent.

In contrast, if small amounts of chromium (Cr), nickel (Ni) and vanadium (V) are added, the resultant dry-etching rates remarkably differ from one another. Since these elements themselves are not dry-etched by a gas which essentially contains fluorine, the addition of a slight amount of any of them can improve the resistance to dry etching. Although not shown in FIG. 2, since hafnium (Hf) and zirconium (Zr) are elements having similar characteristics, they can be adopted as additive elements which improve the resistance to dry etching.

From the above description, if each line (electrode) is formed to have a stacked structure film in which a material having a superior base adhesion and a small resistivity is formed as an underlying thick layer and a film of high dry-etching resistance is formed over the layer, each line (electrode) can satisfy the characteristics required for lines (electrodes) to be formed over an active matrix substrate. Incidentally, if a material having a high resistivity is formed as an underlying layer, it is preferable to form a film of small thickness on the layer.

Contrarily, it is also possible that a material of high dry-etching resistance be formed as an underlying film and a material of small resistivity be formed on the film. In this case, in order that the shape of each stacked line be kept good, the wet-etching rates of both films may be controlled so that the wet-etching rate of the overlying film becomes faster that of the underlying film.

In any of the stacked structure films in which two kinds of line (electrode) materials are stacked, since each of the constituent layers uses a material which essentially contains molybdenum (Mo), the layers can be wet- or dry-etched in bulk with one etching solution or one etching gas.

In the case of dry etching, it is possible to easily perform forward-tapering etching by performing etching while receding a resist which is applied to the upper surface of the two-layer structure film for the purpose of patterning lines (electrodes). In addition, if the materials of the overlying and underlying films are selected so that the dry-etching rate of the overlying film becomes larger than that of the underlying film, it is possible to realize a far better forward tapering.

In the case of wet etching, elements are added to molybdenum (Mo) so that when the stacked structure film is immersed in an etching solution, the corrosion potential of the second layer (overlying layer) becomes lower than that of the first layer (underlying layer). For example, in an etching solution which essentially contains phosphorus, owing to a cell reaction between the overlying and underlying layers with respect to pure molybdenum, the etching rate of the second layer of lower corrosion potential is faster than that of the first layer of higher corrosion potential, whereby a forward-tapered shape can be given to each etched-side end surface of the line (electrode).

In this manner, as an element which improves base adhesion, for example, tungsten (W) or tantalum (Ta) is added to the underlying molybdenum (Mo) of the line (electrode) made of the above-described two-layer stacked structure film. If the added amount of such an element becomes excessively large, the resistivity of the resultant film increases. Therefore, the added amount of the element is controlled so that the resistivity can be kept low. For example, it is possible to increase the added amount of tungsten (W) of low resistivity, but it is preferable to reduce the added amount of tantalum (Ta) of high resistivity.

If a through-hole is to be formed by dry etching in a CVD film (in this case, a SiN film) which constitutes an insulating film, the overlying film of the line (electrode) needs to have resistance to dry etching. For this reason, as described previously, chromium (Cr), nickel (Ni), vanadium (V), hafnium (Hf), zirconium (Zr) and titanium (Ti) are suited as additive elements.

Such a layer of high dry-etching resistance may be the overlying layer of the stacked structure film, but it may also be the underlying layer. In this case, although the overlying film which is poor in resistance to dry etching is dry-etched, the underlying layer functions as an etching stop.

A difference is created between the corrosion potentials of the overlying and underlying layers of the two-layer structure film which is to constitute the line (electrode) layer, and the corrosion potential of the overlying layer is set to be lower than that of the underlying layer. Accordingly, owing to the difference between the corrosion potentials, if both layers are immersed in one etching solution, the etching of the overlying layer proceeds relatively faster than that of the underlying layer by a cell reaction between both layers. Consequently, side etching proceeds in the overlying layer, and the side etching proceeds faster in the upper portion of the underlying layer than in the lower portion of the same.

FIG. 3 is a diagrammatic view illustrating the state of progress of etching due to a cell reaction with a difference being created between the corrosion potentials of the overlying and underlying layers of the two-layer structure film. In a stacked structure film made of an underlying layer 200 and an overlying layer 300 formed over an insulative substrate 100, if there is a difference in corrosion potential between the underlying layer 200 and the overlying layer 300, the etching rate at the interface between the overlying layer 300 and the underlying layer 200 becomes fastest by the influence of a cell reaction in an etching solution.

Consequently, an etched-side end surface 200S of the whole of the underlying layer 200 is formed into a forward-tapered shape, while an end surface 300S of the overlying layer 300 is formed into a shape perpendicular to a surface of the substrate 100 or into a slightly inversely-tapered shape.

In the cross-sectional view of FIG. 3, letting θ be the angle taken in the counterclockwise direction from the deposition surface of each of the stacked films of the insulative substrate 100 to the inclination of the etched-side end surface of the same film, the inclination angle θ₁ of the end surface 200S of the underlying layer 200 is 0°<θ₁<90°, and this is called “forward taper”. The inclination angle θ₂ of the end surface 300S of the overlying layer 300 is 90°≦θ₂, and this is called “inverse taper”.

Incidentally, since the overlying layer 300 serves as a resist against dry etching, i.e., an etching barrier, the overlying layer 300 may have a thickness which enables the overlying layer 300 to resist drying etching for working a through-hole in a protective layer with which the overlying layer 300 (not shown) is coated. Accordingly, the thickness of the overlying layer 300 may be greatly smaller than the thickness of the underlying layer 200. For example, the ratio of the thickness D₁ of the underlying layer 200 to the thickness D₂ of the overlying layer 300 may be D₁:D₂≅9:1, and even if the inverse taper angle θ₂ of the etched-side end surface 300S of the overlying layer 300 is a maximum of 180°, there is no risk of damaging step coverages during the deposition of a protective film at a succeeding step.

In the case where the etching rate of the overlying layer is relatively accelerated by the cell reaction at the interface between the overlying and underlying layers of the stacked structure film made of two different kinds of compositions, it is essential to set the corrosion potential of the underlying layer higher than that of the overlying layer. In addition, if the etched-side end surface of the stacked structure film is to be worked into a forward-tapered shape, it is necessary that the side etching of the overlying layer proceed even during the etching of the underlying layer. Accordingly, the overlying and underlying layers need to be made of the same kind of alloy so that the etching of the overlying and underlying layers can proceed even in the same etching solution, or even if the overlying and underlying layers are made of different kinds of alloys, it is necessary to select materials which can be etched in the same etching solution.

FIG. 4 is an explanatory view of the alloy element-dependence of corrosion potential, illustrating the kinds of alloy elements to be added to molybdenum in a line which contains molybdenum as its main constituent material, as well as differences in corrosion potential in an etching solution for different amounts of addition of each of the elements. In this case, a mixed acid which is made of phosphoric acid, nitric acid, acetic acid and water is used as an etching solution.

In FIG. 4, the corrosion potential of only molybdenum to which no alloy element is added is about 795 mV. As is apparent from FIG. 4, when tungsten (W) is added to molybdenum (Mo), the resultant corrosion potential does not significantly decrease, but when another element (chromium (Cr), titanium (Ti), tantalum (Ta), niobium (Nb), nickel (Ni), zirconium (Zr), vanadium (V) or hafnium (Hf)) is added to molybdenum (Mo), the resultant corrosion potential decreases with an increase in the added amount.

From this fact, if an element other than tungsten (W) is added to the overlying film of the stacked structure film and an alloy element is not added to the underlying film or tungsten (W) is added thereto, it is possible to set the corrosion potential of the overlying film lower than that of the underlying film. Accordingly, it is possible to obtain an etched-side end surface having the shape shown in FIG. 3.

In other words, even if the etching rate of the composition of the underlying layer is faster than that of the composition of the overlying layer, lines having a desired tapered shape can be formed by forming both layers as a stacked structure, irrespective of the etching rates (etching speeds) of the individual overlying and underlying layers.

On the other hand, if the conditions of low resistance and resistance to dry etching are satisfied, the addition of alloy elements may be simply controlled so that the wet-etching rate of the overlying film becomes faster than that of the underlying film. For example, tungsten or zirconium which only exhibits a comparatively small decrease in wet-etching rate may be added to the overlying layer, and the underlying layer may be made of an alloy to which chromium or titanium having a small wet-etching rate is added.

In this manner, since a forward-tapered shape is given to the greater part of each etched-side end surface of a line (electrode) formed on an insulative substrate, the step coverage of an insulating film formed over the line (electrode) is improved to prevent degradation of breakdown voltage. Furthermore, it is possible to solve the problem that a crack occurs in a thin film (CVD film) such as a CVD insulating film in an underlying-layer climb-over portion of another line or electrode (an upper line or electrode) formed above the insulating film, and this crack causes the disconnection of a line or electrode (specifically, a drain line (electrode) or a source line (electrode)) to be deposited over the thin film.

Incidentally, in the case of wet etching using the above-described cell reaction, if the thickness of the overlying layer is significantly smaller than that of the underlying layer, as described previously, it is possible to prevent a defective step coverage of a film to be formed above the overlying layer at a later step, even if each etched-side end surface of the overlying layer has a shape perpendicular to a substrate surface or an inversely-tapered shape.

On the basis of the above-described basic technical ideas of the present invention, it is possible to greatly improve the distribution of the forward taper angle of each line or electrode within the surface of an insulative substrate.

In the case of related art tapering which utilizes the penetration of an etching solution between a resist (photoresist) which serves as an etching mask and a metal thin film to be etched, taper angles vary to a great extent by reflecting within-surface variations in the adhesion between the photoresist and the metal thin film, and an approximately twofold difference in taper angle occurs between the central and peripheral portions of the surface of the insulative substrate. In contrast, if the present invention is used, since the above-described corrosion potential difference is determined for each material to be used, the variations in taper angle of the etched-side end surfaces of etched lines or electrodes within the surface of the insulative substrate become extremely small (in a prototype, such a variation can be controlled within ±9%).

If the present invention is applied to the forming of a gate line in an inverted staggered TFT, the step coverage of each of an insulating film (gate insulating film) made of SiN or the like and formed over the gate line, a semiconductor layer (a—Si semiconductor film), a drain line (electrode) and the like is improved, whereby the breakdown voltage of the TFT is improved and the fraction defective by disconnection of the drain line (electrode) is reduced.

In the case where chromium (Cr) or zirconium (Zr) which is one kind of alloy element, i.e., additive element, is added, the corrosion potential decreases and the resistance to dry etching is improved. Accordingly, an alloy of molybdenum and chromium (Mo—Cr) or zirconium (Mo—Zr) is suited to the overlying film.

Molybdenum (Mo) or an alloy of molybdenum and tungsten (Mo—W) is suited to the underlying film because, in the case of the underlying film, the corrosion potential needs to be high and the resistivity of the line needs to be kept low. The base adhesion is also improved by using the alloy of molybdenum and tungsten (Mo—W).

### BRIEF DESCRIPTION OF THE DRAWINGS

The present invention will be more apparent from the following detailed description, when taken in conjunction with the accompanying drawings, in which:

FIG. 1 is a graph illustrating resistivities which respectively correspond to the amounts by which different kinds of elements are added to molybdenum;

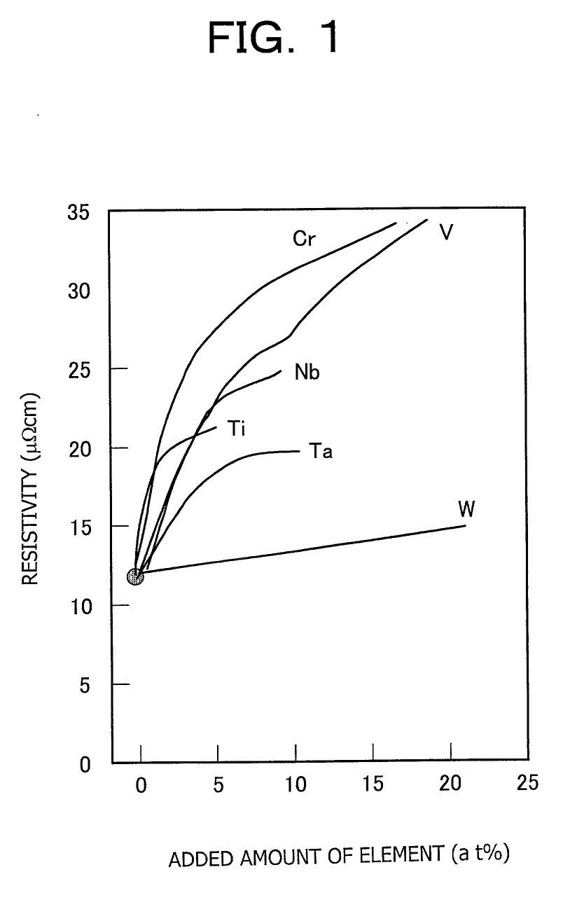

FIG. 2 is a graph illustrating dry-etching rates based on the respective elements added to molybdenum;

FIG. 3 is a diagrammatic view illustrating the state of progress of etching due to a cell reaction with a difference being created between the corrosion potentials of the overlying and underlying layers;

FIG. 4 is an explanatory view of the alloy element-dependence of corrosion potential, illustrating the kinds of alloy elements to be added to molybdenum in a line which contains molybdenum as its main constituent material, as well as differences in corrosion potential in an etching solution for different amounts of addition of each of the elements;

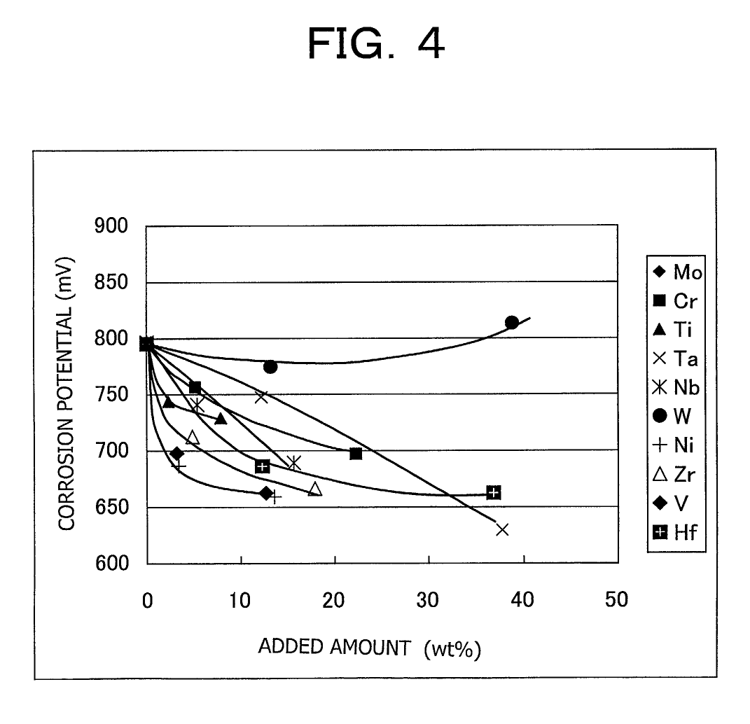

FIG. 5 is a diagrammatic cross-sectional view illustrating the essential structure of a thin film transistor part in a first embodiment of the liquid crystal display device according to the present invention;

FIG. 6 is an explanatory view of the wet-etching rate obtained when each element is added to molybdenum;

FIGS. 7A and 7B are diagrammatic cross-sectional views illustrating an example of the essential structure of a line in a second embodiment of the liquid crystal display device according to the present invention;

FIGS. 8A, 8B and 8C are diagrammatic cross-sectional views illustrating an example of the essential structure of a line in a third embodiment of the liquid crystal display device according to the present invention;

FIGS. 9A, 9B and 9C are diagrammatic cross-sectional views of a terminal portion, illustrating an example of the essential structure of a line portion in a fourth embodiment of the liquid crystal display device according to the present invention;

FIG. 10 is a plan view showing on an enlarged scale the vicinity of one pixel of an active matrix substrate to which the liquid crystal display device according to the present invention is applied;

FIG. 11 is a developed perspective view illustrating the entire construction of an active matrix type liquid crystal display device to which the present invention is applied;

FIG. 12 is a view of the external appearance of a display monitor, showing one example of information equipment in which the liquid crystal display device according to the present invention is mounted; and

FIG. 13 is a diagrammatic cross-sectional view illustrating one example of the essential construction of an active matrix type of liquid crystal display device.

### DESCRIPTION OF THE SPECIFIC EMBODIMENTS

Preferred embodiments of the present invention will be described below in detail.

### First Embodiment

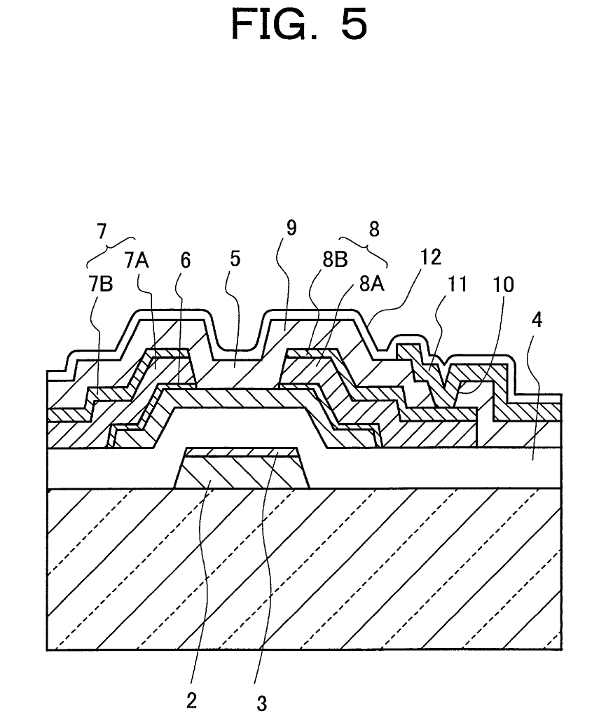

FIG. 5 is a diagrammatic cross-sectional view illustrating the essential structure of a thin film transistor part in the first embodiment of the liquid crystal display device according to the present invention. A Mo-20 wt % W film 2 in which 20 wt % tungsten (W) is added to molybdenum (Mo) and a Mo-1 wt % Cr film 3 in which 1 wt % chromium (Cr) is added to molybdenum are continuously stacked as a gate line on a glass substrate 1 which is an insulative substrate, by a sputtering method.

The thickness of the Mo-20 wt % W film 2 is 180 nm, while the thickness of the Mo-1 wt % Cr film 3 is 20 nm. The resistivity of the Mo-20 wt % W film 2 is 14 μΩcm, while the resistivity of the Mo-1 wt % Cr film 3 is 18 μΩcm.

The average resistivity of the stacked structure film is approximately 16 μΩcm. Since the underlying film 2 is formed of an alloy of molybdenum and tungsten (Mo—W), the substrate adhesion of the film 2 is improved compared to a film formed of only molybdenum. Even if the underlying film 2 is formed of pure Mo of lower resistivity, the overlying film 3 is etched faster, whereby the shape of the stacked structure film can be forward-tapered.

The shape of the gate line (electrode) is formed by applying a resist to the stacked structure film in which the above-described materials are deposited in order, drying the resist, patterning the dried resist with a photolithographic technique, and wet-etching the stacked structure film in bulk by using as an etching solution a mixed acid which is made of phosphoric acid, nitric acid, acetic acid and water.

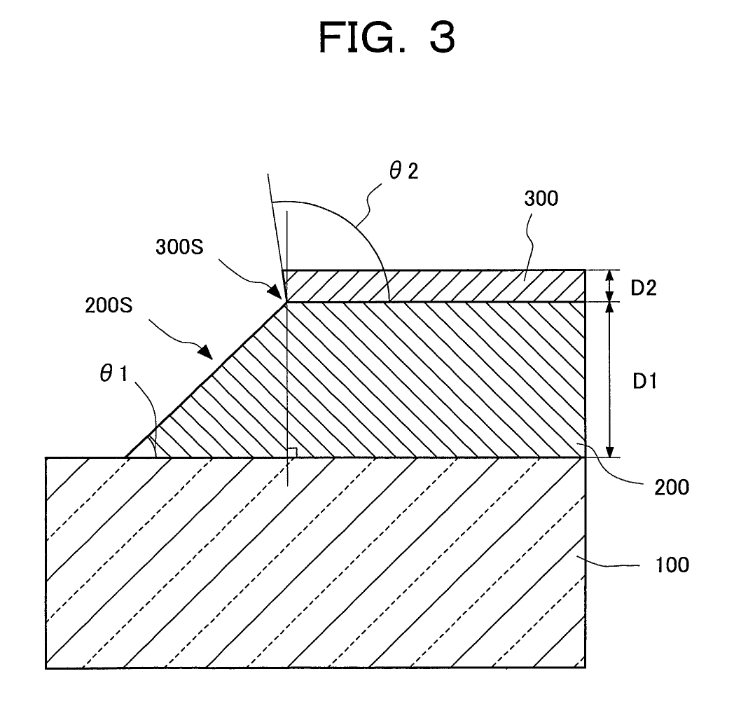

In the etching solution which essentially contains phosphoric acid, the corrosion potential of the Mo-20 wt % W film 2 is 795 mV, while the corrosion potential of the Mo-1 wt % Cr film 3 is 780 mV. Owing to this different between the corrosion potentials, as shown in FIG. 3, the Mo-20 wt % W film which constitutes an overlying film 300 recedes by etching, and subsequently an underlying film 200 is etched. Consequently, the overlying Mo-20 wt % W film is etched to have a forward-tapered shape.

The forward taper angle θ₁ of the underlying film is about 50°, and in addition, the forward taper angle θ₁ can be controlled to be ±5° or less irrespective of the area of an insulative substrate (glass substrate). As described previously, because the interface between both layers is etched earliest, each end surface of the overlying film is formed into a perpendicular shape or an inversely-tapered shape.

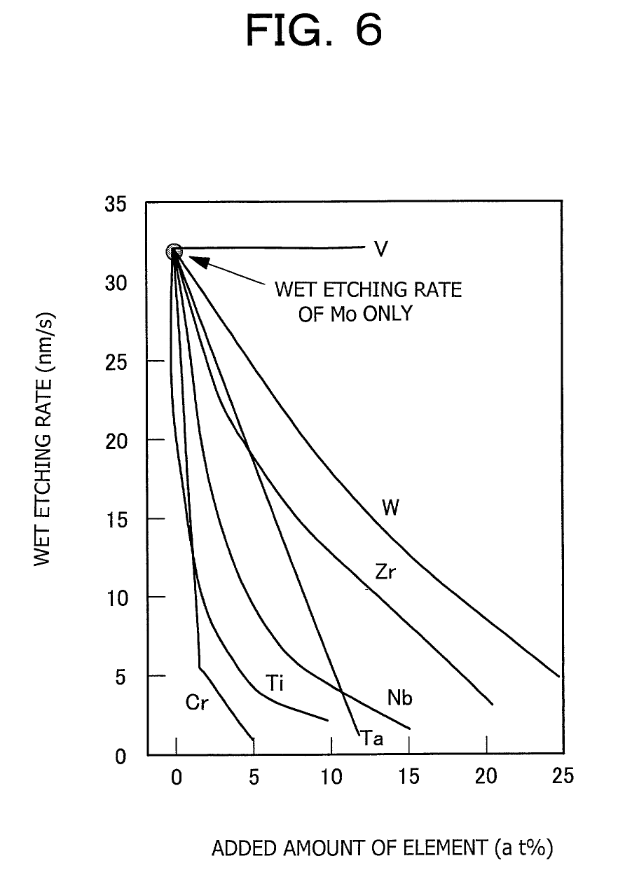

FIG. 6 is an explanatory view of the wet-etching rate obtained when each element is added to molybdenum. As shown, when chromium (Cr) is added to molybdenum (Mo), the tendency of the wet-etching rate to lower is remarkable, and when the stacked structure film is actually etched and subjected to an investigation, the overlying Mo-1 wt % Cr film becomes smaller in etching rate than the Mo-20 wt % W film. If these films are stacked, the relationship between their etching rates thereof is inverted and the overlying Mo—Cr film recedes faster than the underlying one during etching. Consequently, a forward-tapered shape is realized over the entire line (electrode) at each of the etched-side end surfaces thereof. In the case where Mo-1.6 wt % Cr is applied to the overlying film and Mo-2.0 wt % W is applied to the underlying film, the forward taper angle becomes 50°, whereby a good forward-tapered shape is obtained.

When the Mo alloy containing 15-25 wt % (20 wt % 5 wt %) of tungsten as an upper layer and Mo alloy containing 5-10 wt % (8 wt % 3 wt %) of zirconium as a lower layer, the similar good tapered sidewall profiles can be obtained. Since the wet etch rate of the Mo-8 wt % Zr alloy is faster than that of the Mo-1.6 wt % Cr alloy, the lower taper angle of the layered structure, 305 degrees, can be obtained.

As shown in FIG. 5, a SiN film which serves as the gate insulating layer 4, an i—a—Si film which serves as the semiconductor layer 5, and an n⁺a—Si film which serves as the contact layer 6 are continuously formed in that order over the gate line (electrode) which is formed of a two-layer stacked structure film made of the Mo-20 wt % W film 2 and the Mo-1 wt % Cr film 3 in which 1 wt % chromium is added to molybdenum.

During this step, since the thickness of the overlying film 3 of the perpendicularly-formed or inversely-tapered gate line (electrode) is as small as 20 nm, the overlying film 3 is prevented from adversely affecting the shape of the entire line, and the coverage of the CVD film of the SiN film which serves as the gate insulating film 4 is improved. Then, a resist is applied to the top of the contact layer 6, and after the resist is dried, the dried resist is patterned. After the semiconductor layer 5 and the contact layer 6 are respectively worked into island-like shapes by a dry etching process, the resist is peeled.

Then, a drain electrode (line) 7 and a source electrode (line) 8 are formed. Each of the drain electrode 7 and the source electrode (line) 8 is formed by depositing a Mo-20 wt % W film as an underlying film 7A and a Mo-1 wt % Cr film as an overlying film 7B, as in the case of the gate line. During this step, since the gate electrode (line) is formed as a stacked structure film having a good forward taper, disconnections are prevented from occurring in the drain electrode 7 (7A and 7B) and the source electrode 8 (8A and 8B) which are formed over the gate electrode (line).

Since the Mo-20 wt % W film is used as each of the underlying films 7A and 8A, it is possible to improve the adhesion of each of the drain electrode 7 and the source electrode 8 to the semiconductor layer (5 and 6) and the insulating film 4 made of a SiN film. Accordingly, during the wet-etching of the drain electrode (electrode) 7 and the source line (electrode) 8, it is possible to prevent the problem that in a gate-line climb-over portion or the like where the base adhesion is degraded, overetching due to the penetration of an etching solution into a base surface proceeds and disconnection is caused.

Similarly to the gate electrode (line), each of the drain electrode (electrode) 7 and the source line (electrode) 8 is also etched to have a forward taper with a taper angle θ₁ of about 50°, by using an etching solution which essentially contains phosphoric acid. Through a resist which is applied, dried and patterned after this etching process, the contact layer 6 (N⁺a—Si film) which lies in a channel region is removed by dry etching, thereby forming a channel. After that, the resist is peeled.

A SiN film of thickness 400 nm is deposited as a protective film (passivation layer) 9 by a CVD method. By forward-tapering the etched-side end surfaces of each of the drain line (electrode) 7 and the source line (electrode) 8, the step coverage of this passivation layer 9 can be improved.

Then, a through-hole 10 is formed in the passivation layer 9 above the source line (electrode) 8 by dry etching using a gas which essentially contains fluorine.

At the same time, a through-hole is formed in the passivation layer at a terminal portion (not shown) of each of the gate line and the drain line. Even after the completion of the through-hole 10, the source electrode 8 is overetched for a long time until the through-hole in the gate insulating film above the gate terminal is formed. Accordingly, it is necessary to ensure that the overlying film 8B of the source electrode 8 have sufficient resistance to dry etching.

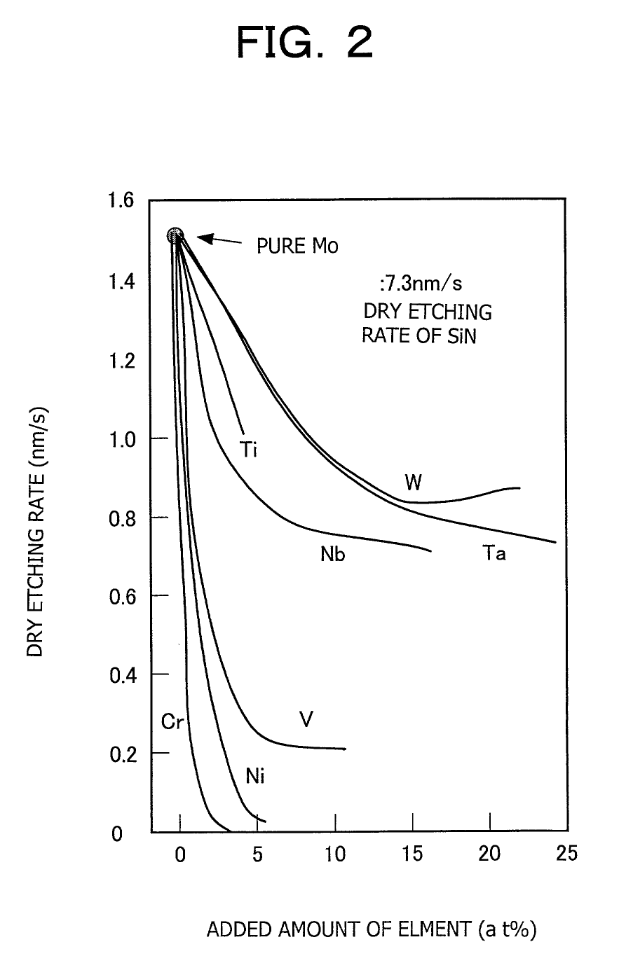

As described previously with reference to FIG. 2, the dry etching rates of all the molybdenum (Mo) films decrease owing to alloying. To ensure the selection ratio 7 of each of the molybdenum films to the SiN film, the addition of niobium (Nb), vanadium (V), chromium (Cr) and nickel (Ni) is effective. Among other things, the addition of a slight amount of chromium (Cr) improves resistance to drying etching to a great extent. In the case of Mo-1 wt % Cr, a selection ratio of 24 can be realized. Incidentally, this term “selection ratio” represents the value obtained by dividing the drying etching rate of SiN film by the drying etching rate of Mo alloy in the case where SF₆ gas is used. After drying etching, a resist is peeled.

After the through-hole 10 has been formed in the source electrode 8, an indium tin oxide (ITO) film is deposited as a pixel electrode 11. The pixel electrode 11 and the source electrode 8 are brought into contact with each other via the through-hole 10. Similarly, an ITO film is brought into contact with the Mo—Cr alloy at the terminal (not shown) of the gate line and at the terminal (not shown) of the drain line. Since molybdenum (Mo) is the main constituent element, the contact resistance against ITO does not increase even if the above-described element is added.

After the ITO film has been deposited as the pixel electrode 11, a resist is applied to the ITO film, and this resist is patterned into the shape of a desired pixel electrode. After that, the ITO film is subjected to wet etching using hydrobromic acid (Hbr) as an etching solution. Since the source electrode 8 has the molybdenum (MO) layer 8B as its upper layer, the source electrode 8 is not etched by HBr via the passivation layer 9 immediately below the through-hole 10. After this etching process, the resist is peeled, and thin film transistors TFT and other active-substrate-side deposition are completed.

According to the first embodiment, since the resistivity of each of the gate line (electrode), the drain line (electrode) and the source line (electrode) is set to approximately 15 μΩcm, the resistance value for the same film thickness can be decreased by about 25% compared to a related-art line (electrode) which is essentially made of chromium (Cr) and has a resistivity of about 20 μΩcm. Accordingly, the first embodiment can cope with a large-area liquid crystal display device.

In addition, since the lines (electrodes) which are essentially made of molybdenum (Mo) are not etched by hydrobromic acid (Hbr) or hydroiodic acid (HI) which is suited to micromachining the ITO films, the ITO electrodes may be disposed at any locations, whereby the first embodiment can cope with any type of TFT structure.

### Second Embodiment

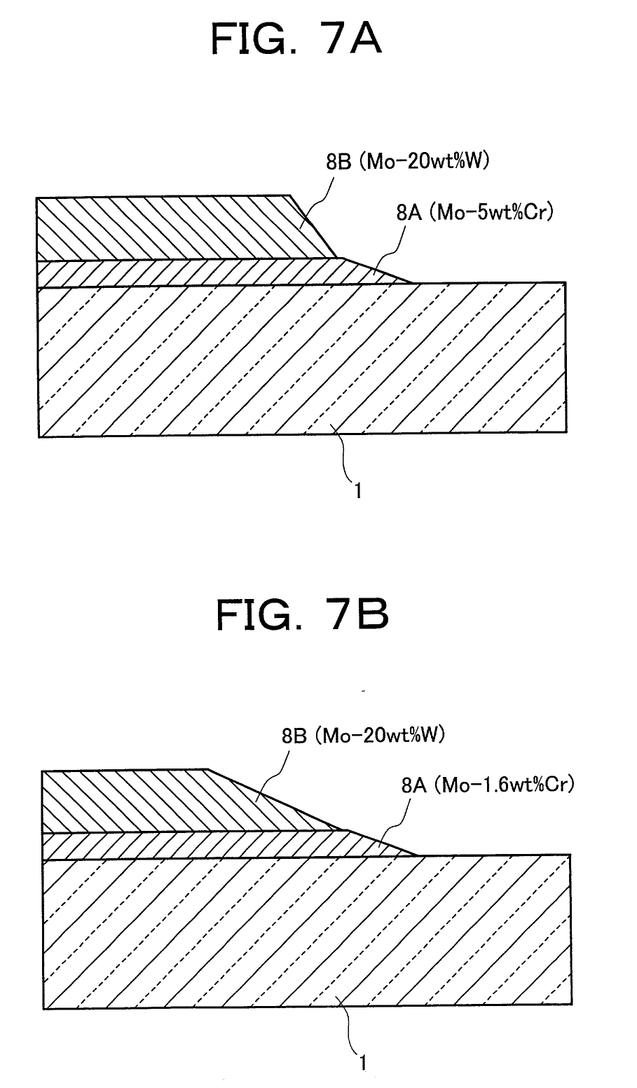

FIGS. 7A and 7B are diagrammatic cross-sectional views illustrating the essential structure of a line in the second embodiment of the liquid crystal display device according to the present invention. Referring to FIGS. 7A and 7B, a Mo-1.0-5 wt % Cr film 8A of thickness 20 nm is deposited on a glass substrate 1, and subsequently, a Mo-20 wt % W film 8B of thickness 200 nm is formed by a sputtering method.

FIG. 7A shows a case in which a Mo-5 wt % Cr film is used, and FIG. 7B shows a case in which a Mo-1.6 wt % Cr film is used. In either case, the resistivity of the underlying film 8A is 16-25 μΩcm, while the resistivity of the overlying film 8B is 16 μΩcm, and the overlying film 8B of lower resistance and larger thickness mainly functions as a line (electrode).

Since both layers can be etched by a mixed acid which is made of phosphoric acid, nitric acid, acetic acid and water, they are etched in bulk as a stacked film. The wet-etching rates of the Mo-5 wt % Cr film (the underlying layer 8A) and the Mo-20 wt % W film (the overlying film 8B) are 1 nm/s and 10 nm/s, respectively.

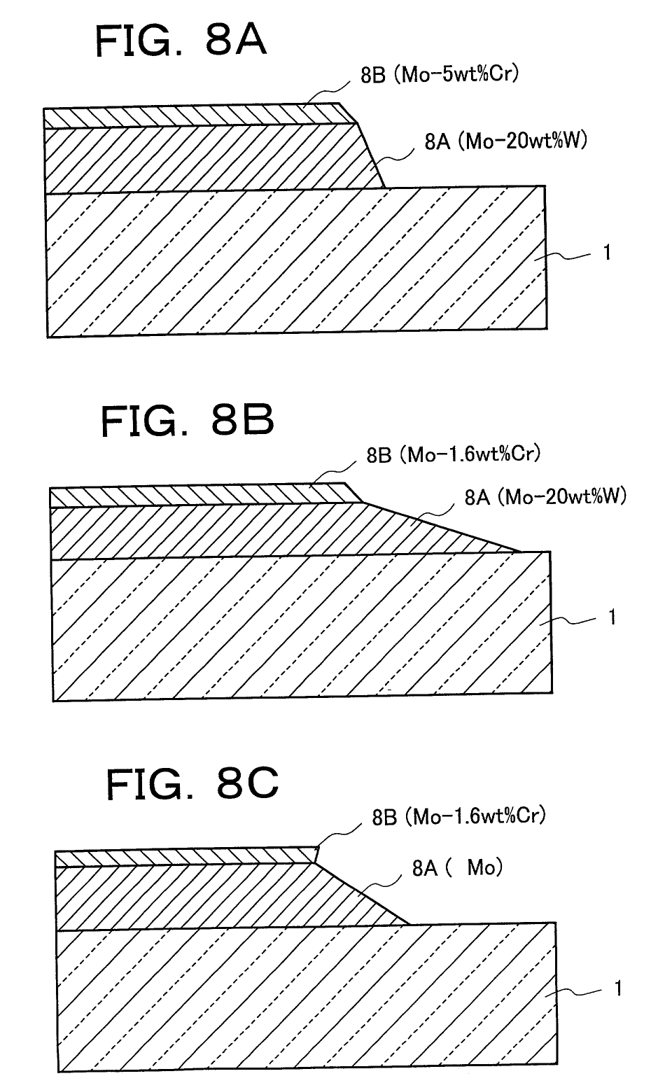

A corrosion potential difference exists between both layers, but since the difference between the etching rates of both layers is as large as about 10 times or more, this difference becomes a factor which dominates the shape of each etched-side end surface. In this case, as shown in FIGS. 8A to 8B, the taper angle of the etched-side end surface is a forward taper angle which is as large as 60-70°. Accordingly, in the case where the difference in etching rate between both layers is large, as shown in FIGS. 7A and 7B, a film having a larger etching rate, i.e., the, is used as the overlying film.

As shown in FIG. 7A, in the case where the Mo-5 wt % Cr film is used as the underlying layer, the underlying film is processed to project from the overlying Mo-20 wt % W film. To forward-taper the overlying film, the composition of an etching solution is selected so that the etching solution can permeate the interface between a resist and the overlying film. By adding tungsten as an alloy element, the wet-etching rate becomes 10 nm/s which is slow compared to pure molybdenum, whereby good forward tapering can be realized. In the case where the Mo-5 wt % Cr film is used as the underlying layer, the taper angle is 45°. In the case where a Mo-1.6 wt % Cr film is used as the base film (underlying film) as shown in FIG. 7B, the taper angle becomes 10° which can realize a good taper shape.

### Third Embodiment

FIGS. 8A, 8B and 8C are diagrammatic cross-sectional views illustrating the essential structure of a line in the third embodiment of the liquid crystal display device according to the present invention. FIG. 8A shows the case where a Mo-20 wt % W film is used as the underlying layer 8A and a Mo-5 wt % Cr film is used as the overlying layer 8B. FIG. 8B shows the case where a Mo-20 wt % W film is used as the underlying layer 8A and a Mo-1.6 wt % Cr film is used as the overlying layer 8B. FIG. 8C shows the case where a pure molybdenum (Mo) film is used as the underlying layer 8A and a Mo-1.6 wt % Cr film is used as the overlying layer 8B.

In either of the cases shown in FIGS. 8A and 8B, it is possible to work the etched-side end surface into a forward-tapered shape, but for the reason described above in connection with FIGS. 7A and 7B, the taper angle of the case shown in FIG. 8A is larger than that of the case shown in FIG. 8B as a whole.

In the case (FIG. 8C) where the pure molybdenum (Mo) film is used as the underlying layer 8A and the Mo-1.6 wt % Cr film is used as the overlying layer 8B, the wet-etching rates of the overlying layer 8B and the underlying layer 8A are 5 nm/s and 32 nm/s, respectively, and the ratio between both layers is approximately 6 times. In this case, the forward-tapering of the pure Mo layer of the underlying layer 8A is possible owing to a cell reaction based on the difference in corrosion potential between both layers in an etching solution.

In this patent, other combination of metals can be applied except Mo alloys, based on the principal concept. If copper (Cu) and molybdenum (Mo) are adopted as the upper and lower layer, respectively, the both layers can be wet etched simultaneously with an etchant.

Furthermore, since the corrosion potential of Mo is set lower than that of Cu in an wet etchant, the upper layer can be etched faster than the lower layer, resulting in a good tapered sidewall profile. If dry-etching resistance is necessary for the upper Mo layer, we had better adopt Mo—Cr or Mo—Zr alloys instead of pure Mo. The resistance of the interconnect can be decreased by adopting Cu as the lower (thick) layer, compared with the pure Mo and Mo—W alloys. The combination of Mo and Cu can satisfy higher specification of the interconnect for large size and high-resolution displays.

The feature of copper (Cu) is described in, for example, AM-LCD96 Digest of Technical papers “Copper-Gate Process for High Information Content a—Si TFT-LCDs”, E. G. Colgan et al. IBM Watson Research Center.

### Fourth Embodiment

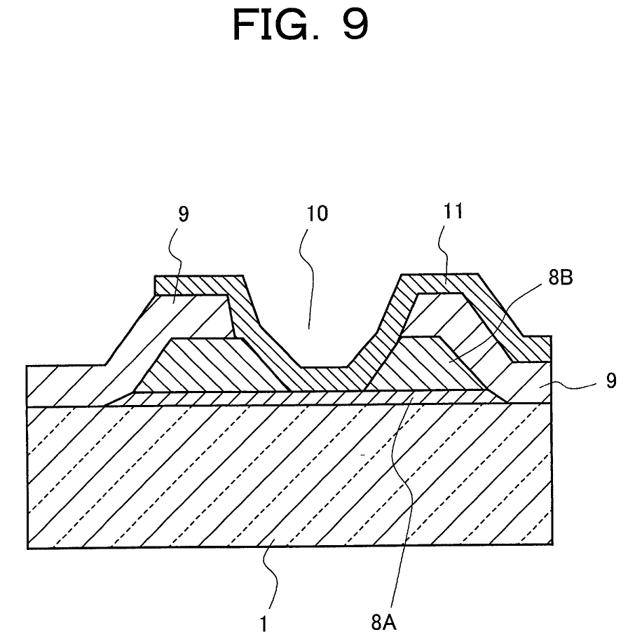

FIGS. 9A, 9B and 9C are diagrammatic cross-sectional views of a terminal portion, illustrating an example of the essential structure of a line portion in the fourth embodiment of the liquid crystal display device according to the present invention. In this embodiment, Mo-5 wt % Cr is used as the underlying layer 8A and Mo-20 wt % W is used as the overlying layer 8B.

After the working of a line made of the underlying layer 8A and the overlying layer 8B, the passivation layer 9 of thickness 300 nm, which is made of an SiN film, is formed over the line by a CVD method. To connect the pixel electrode 11 to this line, the through-hole 10 is formed in the passivation layer 9.

In the case where this through-hole 10 is worked by using SF₆ gas, the dry-etching selection ratio of the underlying layer 8A (Mo-20 wt % W) to the SiN film which forms the passivation layer 9 is about 8, and in the case of a particular thickness of the line, there is a possibility that the underlying layer 8A which constitutes a contact portion is completely etched away. As in the case of the first embodiment, in the case where the through-holes in the passivation layer 9 and the gate SiN film are worked in bulk, the through-hole portion above the source electrode is exposed to long overetching before the working of the gate terminal is completed, although the extent of overetching depends on a period of overetching time. In this case, as shown in FIG. 9, the Mo-20 wt % W layer which constitutes the overlying layer 8B is completely removed by dry etching, and only the Mo-5 wt % Cr of the underlying layer 8A is left. The dry-etching selection ratio of Mo-5 wt % Cr to SiN is 100 or more, and the Mo-5 wt % Cr is not at all etched during this overetching.

Of course, if the thickness of the line is fully large, the Mo-20 wt % W layer can also be left to a sufficient extent even after drying etching. In this case, the line may be formed as a single Mo-20 wt % W layer.

A polycrystalline ITO film is formed on this line as the pixel electrode 11 by a sputtering method. Since the contact resistance between the ITO film and the Mo-5 wt % Cr film is 400 μm² which is fully low, this film construction can be satisfactorily used as the terminals of a driver IC mounted portion. In particular, the film construction can fully cope with the case of a Chip On Glass scheme (COG scheme) in which the input resistance of a driver IC is a problem.

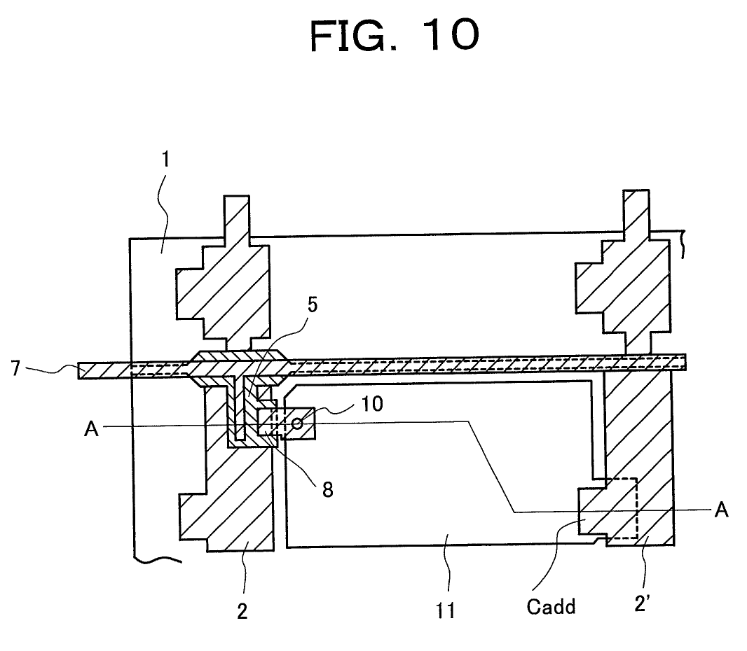

FIG. 10 is a plan view showing on an enlarged scale the vicinity of one pixel of an active matrix substrate to which the liquid crystal display device according to the present invention is applied. In the active matrix substrate (TFT substrate), the gate line 2, a gate line 2′ and the drain line 7 are formed in an intersecting manner over the glass substrate 1 which serves as an insulative substrate, and a thin film transistor TFT is constituted by a gate electrode extending from the gate line 2 (in FIG. 5, the gate electrode shown as the stacked structure film denoted by reference numerals 2 and 3), a drain electrode extending from the drain line 7 (in FIG. 5, the drain electrode 7 shown as the stacked structure film denoted by reference numerals 7A and 7B), the semiconductor layer 5, and the source electrode 8.

The pixel electrode 11 is connected to the source electrode 8 via the through-hole 10 formed in the source electrode 8, and an added capacitance Cadd is formed in an overlapping portion of the adjacent gate line 2′ and the pixel electrode 11. The previously-described portion of the thin film transistor TFT shown in FIG. 5 corresponds to a cross section taken along line A-A of FIG. 10.

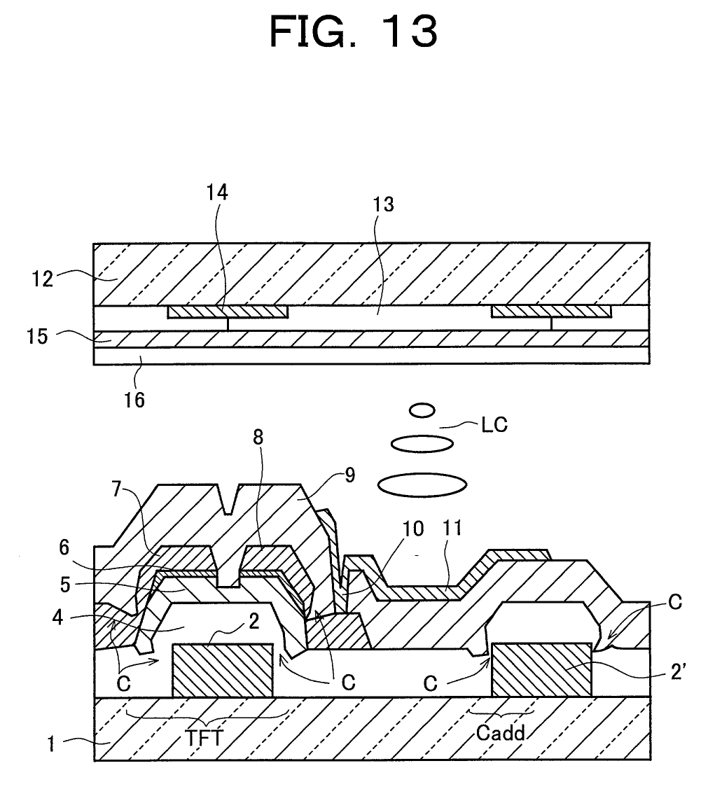

The thin film transistor TFT which constitutes a pixel is turned on by the supply of signals from the gate line 2 and the drain line 7, whereby an electric field is formed between the pixel electrode 11 connected to the source electrode 8 of the turned-on thin film transistor TFT and a counter electrode 15 formed on the color filter substrate 12 shown in FIG. 13. Owing to this electric field, the alignment the molecules of a liquid crystal LC sealed between the active matrix substrate 1 and the color filter substrate 12 is controlled to allow illumination light to be transmitted from a backlight or the like, thereby bringing the liquid crystal LC to the on state.

The added capacitance Cadd formed between the pixel electrode 11 and the adjacent gate line 2′ which differs from the gate line film 2 for driving the thin film transistor TFT is provided for storing a video signal in the pixel electrode 11 for a predetermined time even after the thin film transistor TFT is turned off.

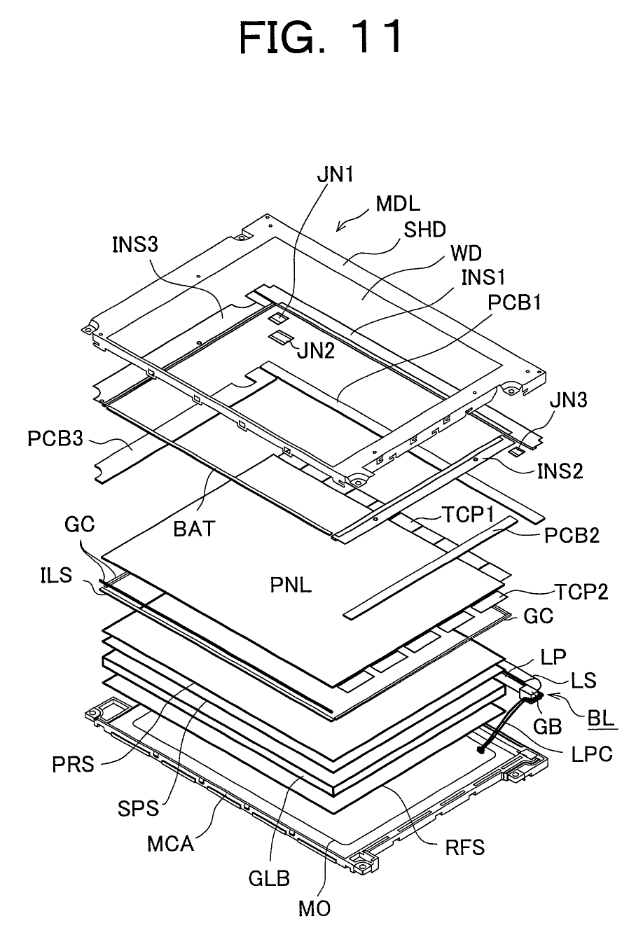

FIG. 11 is a developed perspective view illustrating the entire construction of an active matrix type liquid crystal display device to which the present invention is applied. FIG. 11 illustrates a specific structure of a liquid crystal display device (hereinafter referred to as a module MDL in which a liquid crystal panel, a circuit board, a backlight and other constituent members are integrated).

In FIG. 11, symbol SHD denotes a shield case (also called a metal frame) made from a metal plate, symbol WD a display window; symbols INS1 to INS3 insulating sheets; symbols PCB1 to PCB3 circuit boards (PCB1: a drain side circuit board which is a drain line or video signal line driver circuit board; PCB2: a gate side circuit board which is a gate line or scanning signal line driver circuit board; and PCB3: an interface circuit board); symbols JN1 to JN3 joiners for electrically connecting the circuit boards PCB1 to PCB3; symbols TCP1 and TCP2 tape carrier packages; symbol PNL a liquid crystal panel; symbol GC a rubber cushion; symbol ILS a light shield spacer; symbol PRS a prism sheet; symbol SPS a diffusing sheet; symbol GLB a light guide plate; symbol RFS a reflecting sheet; symbol MCA a lower case (a mold frame) formed by integral molding; symbol MO an aperture of the lower case MCA; symbol LP a fluorescent lamp; symbol LPC a lamp cable; symbol GB a rubber bushing which supports the fluorescent lamp LP; symbol BAT a double-faced adhesive tape; and symbol BL a backlight made of the fluorescent lamp LP, the light guide plate GLB and the like. The diffusing sheet members are stacked in the shown arrangement to assemble the liquid crystal display module MDL.

The liquid crystal display MDL has a case made of two kinds of accommodating/holding members, the lower frame MCA and the upper frame SHD, and is constructed by joining the shield case SHD and the lower case MCA together. The insulating sheets INS1 to INS3, the circuit boards PCB1 to PCB3 and the liquid crystal display panel PNL are fixedly accommodated in the shield case SHD, and the backlight BL made of the fluorescent lamp LP, the light guide plate GLB, the prism sheet PRS and the like is accommodated in the lower case MCA.

An integrated circuit chip for driving the individual pixels of the liquid crystal display panel PNL is mounted on the drain side driver circuit board PCB1, while electronic components are mounted on the interface circuit board PCB3, such as an integrated circuit ship for receiving video signals from an external host computer and control signals such as timing signals and a timing converter TCON for processing timing and generating clock signals.

The clock signals generated by the timing converter are supplied to the integrated circuit chip which is mounted on the video signal line driver circuit board PCB1, via clock signal lines CLL which are formed on the interface circuit board PCB3 and the video signal line driver circuit board PCB1.

The drain side circuit board PCB1 for driving TFTs, the gate side circuit board PCB2 and the interface circuit board PCB3 are connected to the liquid crystal display panel PNL by the tape carrier packages TCP1 and TCP2. The individual circuit boards are interconnected by the joiners JN1, JN2 and JN3.

The interface circuit board PCB3 and the video signal line driver circuit board PCB1 are multi-layered wiring boards, and the clock signal lines CLL are formed as inner-layer lines of the interface circuit board PCB3 and the video signal line driver circuit board PCB1.

The liquid crystal panel PNL includes two substrates stuck together and a liquid crystal sealed in the gap therebetween. One of the two substrates is a TFT substrate over which the above-described TFTs and various lines (electrodes) are formed, and the other is a filter substrate over which color filters are formed. The drain side circuit board PCB1 for driving the TFTs, the gate side circuit board PCB2 and the interface circuit board PCB3 are connected to the liquid crystal panel PNL by the tape carrier packages TCP1 and TCP2, and the individual circuit boards are interconnected by the joiners JN1, JN2 and JN3. Incidentally, it is not necessary to use such tape carrier packages in a scheme (Chip On Glass: COG, or an FCA scheme) in which driver circuits (IC chips) are directly mounted on an insulative substrate of a liquid crystal panel which constitutes a liquid crystal display device. It goes without saying that the present invention can similarly be applied to this mounting scheme.

According to the above-described liquid crystal display module, it is possible to provide a highly reliable liquid crystal display device which makes it possible to reduce the number of steps of manufacturing various lines and electrodes for a liquid crystal panel which constitutes the liquid crystal display device, as well as in which the occurrence of disconnection or the like is suppressed.

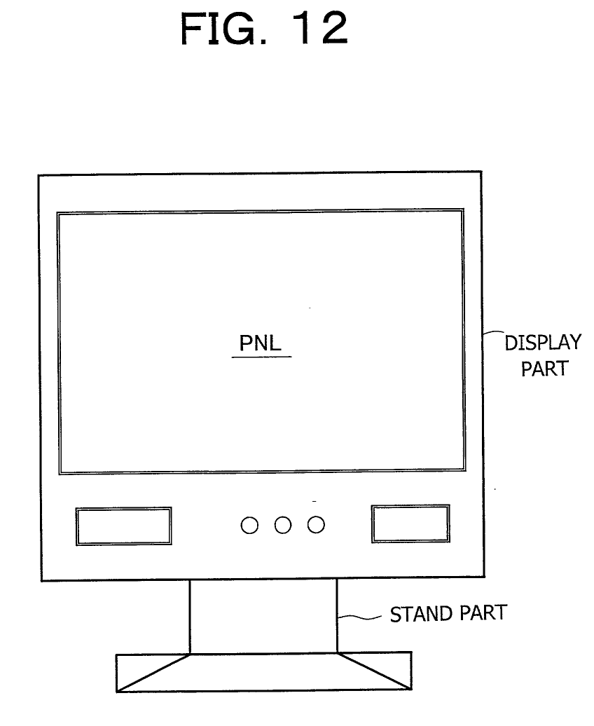

FIG. 12 is a view of the external appearance of a display monitor, showing one example of information equipment in which the liquid crystal display device according to the present invention is mounted. This display monitor is made of a display part and a stand part, and displays a picture signal supplied from a display signal source such as a separate host computer. Incidentally, a host computer or a television receiver circuit may be built in the stand part, and the display monitor can be used as not only a monitor for a personal computer but also a television receiver. The present invention is not limited to the above-described thin film transistor type of active matrix liquid crystal display device, and can also similarly be applied to the patterning of lines or electrodes for other types of liquid crystal display devices or other semiconductor elements.

As is apparent from the foregoing description, according to the present invention, it is possible to give good forward-tapered shapes to the etched-side end surfaces of, particularly, each scanning signal line formed on an active matrix substrate, whereby the coverage of individual kinds of thin films positioned over the scanning signal lines is improved and it is possible to prevent cracks or pinholes in such thin films, film defects such as disconnections of lines or electrodes, or a short-circuit between overlying and underlying layers. Accordingly, it is possible to provide a liquid crystal display device which has high reliability and is capable of displaying a high-quality picture.

In addition, according to the present invention, since the above-described lines and electrodes are formed as a stacked structure film and the etched-side end surfaces of the underlying layers are given forward-tapered shapes, the unevenness of a surface of a thin film transistor substrate can be made mild and defective alignment or the like of liquid crystal can be restrained. Accordingly, it is possible to provide a liquid crystal display device having good contrast.

Moreover, the present invention is not limited to a so-called vertical electric field type (TN type) of liquid crystal display device, and can also similarly be applied to a so-called In-Plane Switching mode (IPS mode) of liquid crystal display device in which counter electrodes are formed over an active matrix substrate, or to another type of liquid crystal display device which has climb-over portions in each of which electrode lines intersect with each other, or to similar kinds of semiconductor devices. In any case, the present invention can achieve advantages similar to the above-described ones.

What is claimed is:

1. A liquid crystal display device comprising:
a line or an electrode having a stacked structure comprising a first metal layer formed over an insulative substrate and a second metal layer and formed over said first metal layer, said first metal layer having a corrosion potential different from said second metal layer,
said first metal layer and said second metal layer being made of Mo alloys which differ from each other in at least one additive element.

2. The liquid crystal display device according to claim 1 wherein said first metal layer comprises pure molybdenum or a molybdenum alloy containing tungsten or tantalum as an additive element, and
said second metal layer comprises chromium or a molybdenum alloy containing hafnium, zirconium, vanadium, nickel or titanium as an additive element.

3. The liquid crystal display device according to claim 1 wherein each side end of said first metal layer has a forward-tapered shape,
each side end of said second metal layer has a perpendicular or inversely-tapered shape,
said first metal layer being a molybdenum alloy containing tungsten or tantalum as an additive element, and
said second metal layer being a molybdenum alloy containing hafnium, zirconium, vanadium, nickel or titanium as an additive element.

4. The liquid crystal display device according to claim 1 wherein each side end of said first metal layer has a forward taper angle θ₁ in the range of 10°-50°, and
each side end of said second metal layer has an inverse taper angle θ₂ in the range of 90°-180°.

5. The liquid crystal display device according to claim 4 wherein said forward taper angle θ₁ is 30°±5°.

6. A liquid crystal display device comprising a line or an electrode having a stacked structure formed of a first layer comprising molybdenum and a second molybdenum alloy layer disposed over an insulative substrate,
said second molybdenum alloy layer being different in corrosion potential from said first layer,
one of said first layer and said second molybdenum alloy layer having a resistivity of 20 μΩcm or less, and the other having a selectivity of a dry-etching rate of 7 or more.

7. The liquid crystal display device according to claim 6 wherein said first layer is formed on said insulative substrate and has a selectivity of a dry-etching rate of 7 or more, and
said second molybdenum alloy layer is formed on said first layer and has a resistivity of 20 μΩcm or less.

8. The liquid crystal display device according to claim 6 wherein said first layer is made of pure molybdenum or a molybdenum alloy which contains tungsten or tantalum as an additive element, and
said second molybdenum alloy layer contains at least one additive element from among chromium, nickel, vanadium, hafnium, zirconium and titanium.

9. The liquid crystal display device according to any of claim 7 and claim 8 wherein said first molybdenum alloy layer has a thickness greater than said second molybdenum alloy layer.

10. A liquid crystal display device comprising:
a first insulative substrate including plural lines containing a gate line and a drain line; and
an active element connected to said gate line and said drain line for controlling the ON/OFF state of a pixel,
wherein said gate line is a stacked structure comprising a first layer disposed on said first insulative substrate and made of pure molybdenum or a molybdenum alloy containing tungsten or tantalum as an additive element, and a second layer formed on said first layer and made of a molybdenum alloy containing chromium, hafnium or zirconium as an additive element,
each side end surface of said first layer having a forward-tapered shape,
each side end surface of said second layer having a shape perpendicular to said substrate surface or an inversely-tapered shape.

11. The liquid crystal display device according to claim 10 wherein said second layer has a different in corrosion potential from that of said first layer.

12. The liquid crystal display device according to claim 10 wherein each side end of said first layer has a forward taper angle θ₁ in the range of 10°-50°, and
each side end of said second layer has an inverse taper angle θ₂ in the range of 90°-180°.

13. The liquid crystal display device according to claim 12 wherein said forward taper angle θ₁ is 30°±5°.

14. The liquid crystal display device according to claim 10 further including a second insulative substrate,
at least a color filter formed on one of said first and second insulative substrates with a small gap interposed therebetween; and
a liquid crystal sealed in said small gap between said first and second insulative substrates.

15. The liquid crystal display device according to claim 10 further including a chemical vapor deposition layer formed over said gate line.

16. The liquid crystal display device according to claim 15 wherein said drain line is formed on said chemical vapor deposition layer, and a protective film is formed over said drain line.

17. A liquid crystal display device comprising:
a pair of substrates;
a liquid crystal layer interposed between said pair of substrates;
a line or an electrode including a lower layer and an upper layer formed on one of said pair of substrates;
said upper layer having a corrosion potential different from said lower layer;
said lower layer is a molybdenum alloy having tungsten as an additive element; and
said upper layer is a molybdenum alloy having zirconium as an additive element.

18. The liquid crystal display device according to claim 17 wherein a weight % of tungsten is in the range of 15% -25%, and a weight % of zirconium is in the range of 5% -10%.

19. The liquid crystal display device according to claim 17 wherein each side end of said lower layer has a forward taper angle θ₁ in the range of 10°-50°, and
each side end of said upper layer has an inverse taper angle θ₂ in the range of 90°-180°.

20. The liquid crystal display device according to claim 17 wherein said forward taper angle θ₁ is 30°±5°.
